(19) United States
(12) Patent Application Publication
(10) Pub. No.: US 2005/0095382 A1
(43) Pub. Date: May 5, 2005

(54) Memo sheet

(76) Inventors: Tsung-Tien Kuo, Niao-Sung Hsiang (TW); Jen-Rong Liu, Feng-Shan City (TW); Chin-Chung Tsai, Pan-Chiao City (TW)

Correspondence Address: FROMMER LAWRENCE & HAUG, 745 FIFTH AVENUE- 10TH FL., NEW YORK, NY, 10151, US

(21) Appl. No.: 10/696,872

(22) Filed: Oct. 30, 2003

(51) Int. Cl. B32B 9/00

(52) U.S. Cl. 428/40.1

(57) ABSTRACT

A memo sheet includes a sheet member having opposite first and back sides, a fold line dividing the sheet member into cover and hidden parts, and a removable pressure sensitive adhesive layer. Each of the cover and hidden parts has a marking face arranged at the front side of the sheet member, and a back face arranged at the back side of the sheet member. The adhesive layer is provided on the back face of the hidden part. The sheet member is foldable along the fold line to adhere the back face of the hidden part over the back face of the cover part through the adhesive layer so that the marking face of the hidden part is placed opposite to the marking face of the cover part.

### BACKGROUND OF THE INVENTION

1. Field of the Invention

The invention relates to a memo sheet, more particularly to a memo sheet with cover and hidden parts.

2. Description of the Related Art

Referring to FIGS. 1 and 2, a record book or pad, as disclosed in European Patent Application No. 0601696, comprises record and removable sheets 11, 12 in an overlying relationship, and direct image transfer means 13 between the record and removable sheets 11, 12. The record and removable sheets 11, 12 are disposed alternately so that a removable sheet 12 overlies a record sheet 11 in each pair. When a message is written on the removable sheet 12, due to a writing pressure applied to the direct image transfer means 13, the message is reproduced on the record sheet 11 that is paired with the removable sheet 12.

This reference further discloses an adhesive line 14 provided on one side of each record sheet 11 so that when the removable sheet 12 is removed, the record sheet 11 can be folded and remain folded through the adhesive line 14 so as to hide the message.

Referring to FIG. 3, a confidential message envelope disclosed in British Patent Application No. 2238016 comprises three sheets 21, 22, 23 disposed one above the other. The middle and back sheets 22, 23 are joined together in a releasably sealed manner to define an inner envelope. The front sheet 21 is releasably joined to the inner envelope. The middle sheet 23 includes a layer of ink or like marking material (not shown) on its reverse side. When a message is written on the front sheet 21, through the ink layer, the message is transferred to the back sheet 23 but not on the middle sheet 22, after which the front sheet 21 can be detached from the inner envelope. The intended recipient separates the middle sheet 22 from the back sheet 23 to reveal the message.

The aforementioned references use respectively the direct image transfer means 13 and the ink layer to reproduce and to transfer the message onto the respective record sheet 11 and back sheet 23. Moreover, different hiding methods, such as by folding or by covering with a cover, are employed to hide the message.

However, the products of the aforementioned references face the same drawback, that is, a material with a duplicating or transferring function must be applied onto one of the layers of the structure, so that the message can be duplicated or transferred, as in these cases, from the removable sheet 12 to the record sheet 11 or from the front sheet 21 to the back sheet 23. The whole production process is accordingly relatively complicated. Moreover, the products of the aforementioned references are not provided with an adhering positioning effect for adhering the message on a surface. As a consequence, the message is often lost and is not relayed to the intended recipient.

### SUMMARY OF THE INVENTION

Therefore, the object of the present invention is to provide a memo sheet that is capable of overcoming the aforementioned drawbacks of the prior art.

According to this invention, a memo sheet comprises a sheet member, a fold line, and a releaseable adhesive layer. The sheet member has a front side and a back side opposite to the front side. The fold line is formed on and divides the sheet member into a cover part and a hidden part. Each of the cover and hidden parts has a marking face and a back face opposite to the marking face. The marking faces of the cover and hidden parts are arranged at the front side of the sheet member. The back faces of the cover and hidden parts are arranged at the back side of the sheet member. The sheet member is foldable along the fold line to place the back face of the hidden part over the back face of the cover part. The adhesive layer is provided on the back face of one of the cover and hidden parts. The back face of the hidden part is adhered to the back face of the cover part through the adhesive layer when the sheet member is folded. The marking face of the hidden part is placed opposite to the marking face of the cover part when the sheet member is folded.

### BRIEF DESCRIPTION OF THE DRAWINGS

Other features and advantages of the present invention will become apparent in the following detailed description of the preferred embodiments with reference to the accompanying drawings, of which:

FIGS. 1 and 2 illustrate a record book or pad disclosed in European Patent Application No. 0601696;

FIG. 3 illustrates a confidential message envelope disclosed in British Patent Application No. 2238016;

FIG. 4 is a perspective view of the first preferred embodiment of a memo sheet according to the present invention, illustrating the memo sheets of the present invention arranged in a stack;

FIG. 5 is a side sectional view of the first preferred embodiment;

FIG. 6 illustrates the first preferred embodiment in a state of use;

FIG. 7 is a perspective view of the second preferred embodiment of a memo sheet according to the present invention; and

FIG. 8 is a perspective view of the third preferred embodiment of a memo sheet according to the present invention.

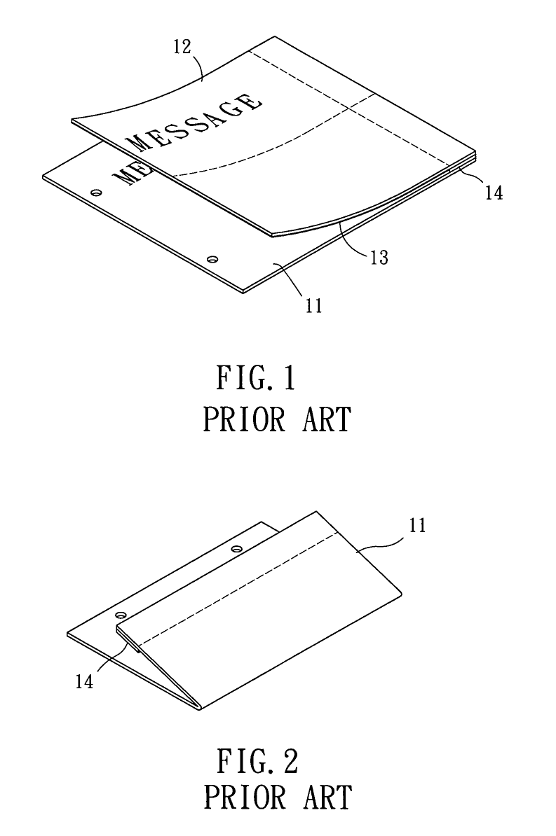

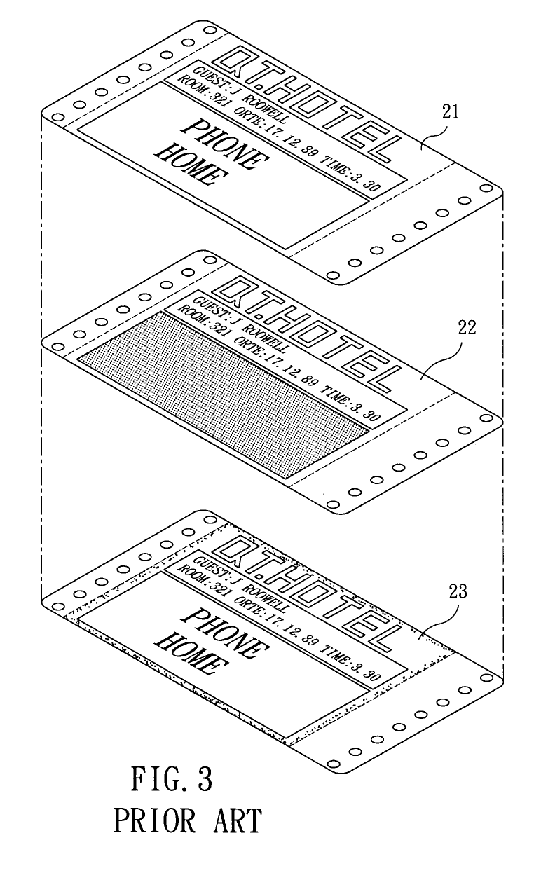

### DETAILED DESCRIPTION OF THE PREFERRED EMBODIMENTS

Before the present invention is described in greater detail, it should be noted that like elements are denoted by the same reference numerals throughout the disclosure.

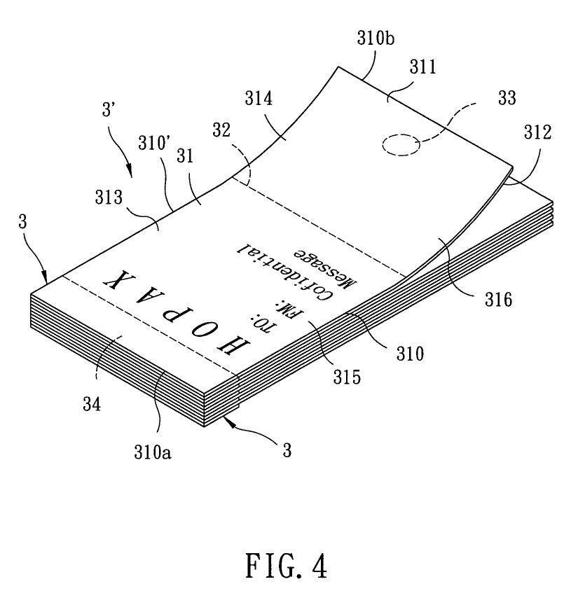

Referring to FIGS. 4, 5 and 6, the first preferred embodiment of a memo sheet 3 according to the present invention is shown to comprise a sheet member 31, a fold line 32, a first adhesive layer 33, and a second adhesive layer 34.

The sheet member 31 has a rectangular cross-section, a front side 311, a back side 312 opposite to the front side 311, opposite first and second side edges 310, 310′ extending in a longitudinal direction, and third and fourth side edges 310a, 310b extending in a transverse direction relative to the longitudinal direction.

The fold line 32 is formed on the sheet member 31 and extends in the transverse direction from the first side edge 310 to the second side edge 310′ so as to divide the sheet member 31 into a cover part 313 and a hidden part 314. Preferably, the hidden part 314 has an area smaller than that of the cover part 313. The cover part 313 can be initially printed with different words. In this embodiment, the fold line 32 is a marked line. Each of the cover and hidden parts 313, 314 has a marking face 315, 316 and a back face 317, 318 opposite to the marking face 315, 316. The marking faces 315, 316 of the cover and hidden parts 313, 314 are arranged at the front side 311 of the sheet member 31. The back faces 317, 318 of the cover and hidden parts 313, 314 are arranged at the back side 312 of the sheet member 31.

In this embodiment, the first adhesive layer 33 is made of a removable pressure sensitive adhesive, which is a resin containing elastomeric microsphere or micro particles. The first adhesive layer 33 is circular, and is provided on the back face 318 of the hidden part 314 of the sheet member 31 in the preferred embodiment. When the sheet member 31 is folded, the back face 318 of the hidden part 314 is adhered to the back face 317 of the cover part 313 through the first adhesive layer 33. As such, the marking face 316 of the hidden part 314 is placed opposite to the marking face 315 of the cover part 313 when the sheet member 31 is folded.

The second adhesive layer 34 is also made of a removable pressure sensitive adhesive, and is provided on the back face 317 of the cover part 313 of the sheet member 31 in this embodiment. Moreover, in this embodiment, the second adhesive layer 34 is an adhesive strip extending from the first side edge 310 to the second side edge 310′ of the sheet member 31, and is disposed adjacent to the third side edge 310a of the sheet member 31.

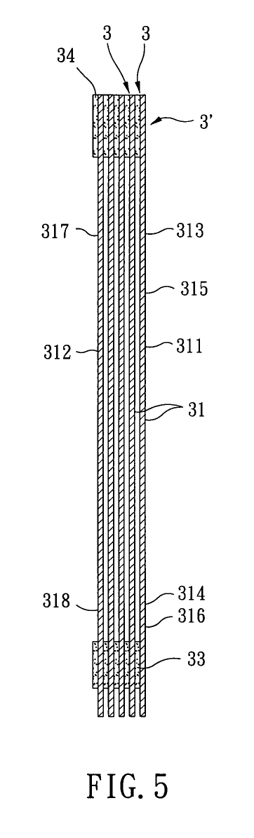

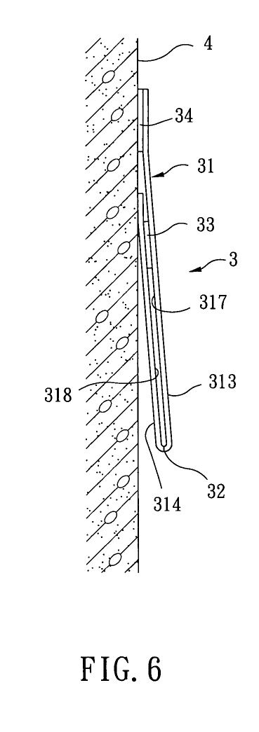

In a state prior to use, a plurality of memo sheets 3 are stacked to form a memo pad 3′ (see FIGS. 4 and 5) so as to facilitate storage. If use of the memo sheet 3 is desired, the uppermost sheet member 31 of the memo pad 3′ is removed. The name of the recipient and the name of the sender are written on the marking face 315 (see FIG. 4) of the cover part 313, while a message (not shown) is written on the marking face 316 (see FIG. 4) of the hidden part 314. Then, the sheet member 31 is folded along the fold line 32 in such a manner that the back face 318 of the hidden part 314 is placed over the back face 317 of the cover part 313 and such that a portion of the back face 317 of the cover part 313 is hidden, and the other portion thereof is exposed, as best illustrated in FIG. 6. The second adhesive layer 34 is located on the exposed portion of the back face 317 of the cover part 313. The hidden part 314 of the sheet member 31 remains folded at this time due to effect of the first adhesive layer 33 on the back face 317 of the cover part 313 so as to hide the message.

The folded sheet member 31 is then adhered to a surface, such as a wall surface 4 (see FIG. 6). The folded sheet member 31 is adhered temporarily and releasably to the wall surface 4 through the removable pressure sensitive property of the second adhesive layer 34, and can be repeatedly applied to other surfaces, such as a computer monitor or a working table surface. The message is further hidden between the cover part 313 and the wall surface 4, thereby achieving the purpose of keeping the message hidden. When the intended recipient wishes to read the message, he/she simply detaches the memo sheet 3 from the wall surface 4 and unfolds the sheet member 31.

It is noted that the memo sheet 3 of the present invention uses the fold line 32 to divide the sheet member 31 into the cover part 313, which is exposed for public viewing, and the hidden part 314, where a written message is hidden by the cover part 313. The sheet member 31 is foldable along the fold line 32, and remains folded through the effect of the first adhesive layer 33 on the back face 317 of the cover part 313 so as to hide the message on the hidden part 314. The hidden part 314 is further hidden between the cover part 313 and the wall surface 4 through the removable pressure sensitive property of the second adhesive layer 34, thereby completely dispensing with the need for a multi-layered duplicate or transfer means to achieve the purpose of hiding messages.

Furthermore, the first adhesive layer 33 and the second adhesive layer 34 are disposed on the back side 312 of the sheet member 31 so that writing on the front side 311 of the sheet member 3 is smooth.

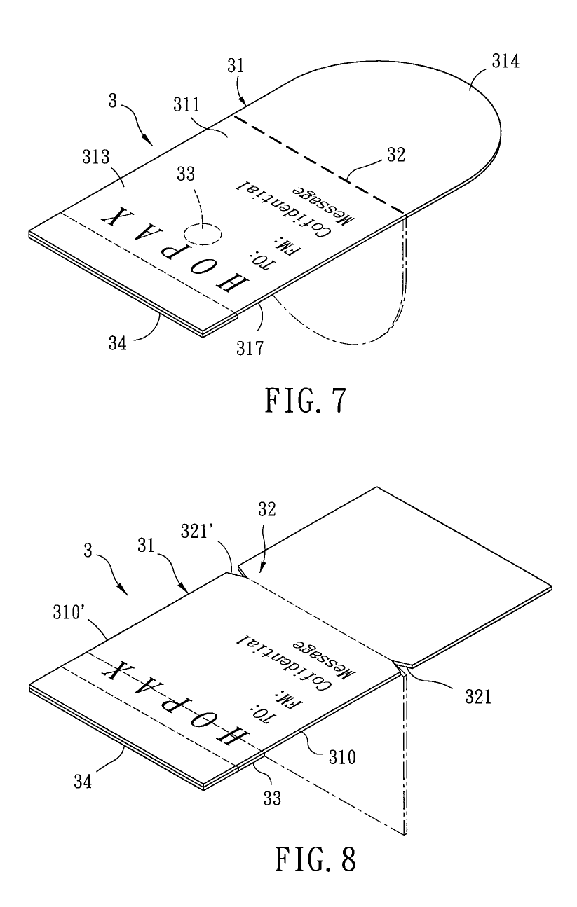

Referring to FIG. 7, the second preferred embodiment of the memo sheet 3 according to the present invention is shown to be substantially similar to the first preferred embodiment. However, in this embodiment, the hidden part 314 of the sheet member 31 has a semi-oval shape. The first adhesive layer 33 is provided on the back face 317 of the cover part 313, and is disposed adjacent to the second adhesive layer 34. The fold line 32, in this embodiment, is a scored line.

Referring to FIG. 8, the third preferred embodiment of the memo sheet 3 according to the present invention is shown to be substantially similar to the first preferred embodiment. However, in this embodiment, the first and second side edges 310, 310′ of the sheet member 31 are formed respectively with first and second cutout portions 321, 321′. The fold line 32 extends from the first cutout portion 321 to the second cutout portion 321′. The first adhesive layer 33 is an adhesive strip extending from the first side edge 310 to the second side edge 310′ of the sheet member 31, and is disposed adjacent to the second adhesive layer 34.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A memo sheet comprising:
a sheet member having a front side and a back side opposite to said front side;
a fold line formed on and dividing said sheet member into a cover part and a hidden part, each of said cover and hidden parts having a marking face and a back face opposite to said marking face, said marking faces of said cover and hidden parts being arranged at said front side of said sheet member, said back faces of said cover and hidden parts being arranged at said back side of said sheet member, said sheet member being foldable along said fold line to place said back face of said hidden part over said back face of said cover part; and
a removable pressure sensitive first adhesive layer provided on said back face of one of said cover and hidden parts,
wherein said back face of said hidden part is adhered to said back face of said cover part through said first adhesive layer when said sheet member is folded, whereby said marking face of said hidden part is placed opposite to said marking face of said cover part.

2. The memo sheet as claimed in claim 1, further comprising a removable pressure sensitive second adhesive layer provided on said back face of said cover part, said back face of said cover part having a hidden portion covered by said hidden part when said sheet member is folded, and an exposed portion where said second adhesive layer is located.

3. The memo sheet as claimed in claim 1, wherein said first adhesive layer is provided on said back face of said hidden part.

4. The memo sheet as claimed in claim 2, wherein said first adhesive layer is provided on said back face of said cover part adjacent to said second adhesive layer.

5. The memo sheet as claimed in claim 1, wherein said fold line is a marked line.

6. The memo sheet as claimed in claim 1, wherein said fold line is a scored line.

7. The memo sheet as claimed in claim 1, wherein said sheet member has opposite first and second side edges extending in a transverse direction relative to said fold line and formed respectively with first and second cutout portions, said fold line extending from said first cutout portion to said second cutout portion.

8. The memo sheet as claimed in claim 1, wherein said hidden part has an area smaller than that of said cover part.
